(19) United States
(12) Patent Application Publication
(10) Pub. No.: US 2009/0041166 A1
(43) Pub. Date: Feb. 12, 2009

(54) Method and apparatus to improve information decoding when its characteristics are known a priori

(75) Inventors: Bhaskar Patel, San Clemente, CA (US); Arumugam Govindswamy, Irvine, CA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: MBIT WIRELESS, INC., Newport Beach, CA (US)

(21) Appl. No.: 12/228,189

(22) Filed: Aug. 11, 2008

Related U.S. Application Data
(60) Provisional application No. 60/964,047, filed on Aug. 9, 2007.

(51) Int. Cl. H04L 27/06

(52) U.S. Cl. 375/341

(57) ABSTRACT

The present invention provides systems and methods for decoding received messages using a priori characteristics of selected message portions. A message which has been encoded in a particular format, such as a tail-biting convolutional coding, is received and decoded by utilizing the a priori information about the message. In one case, static-type receive bits in a portion of the message, such as a Frame Control Header, are used to reduce the number of trellis states at particular stages of the decoding process. A Viterbi-type decoding process may be employed in either a soft or hard decision mode. Reducing the number of trellis states improves the success rate for message decoding and improves receiver throughput. Power consumption may also be reduced.

### CROSS-REFERENCE TO RELATED APPLICATION

This application claims the benefit of the filing date of U.S. Provisional Patent Application No. 60/964,047, filed Aug. 9, 2007, and entitled “Method and Apparatus to Improve Information Decoding when its characteristics are known a priori,” the entire disclosure of which is hereby expressly incorporated by reference herein.

### BACKGROUND OF THE INVENTION

1. Field of the Invention

The present invention relates generally to digital communication systems that use error correcting codes and, more particularly, to decoders for error correcting codes used in digital communication systems.

2. Description of Related Art

Digital communication systems provide increased robustness to noise and other impairments during propagation compared to analog communication systems. The robustness to noise and other impairments may be further improved in digital communication systems by the use of error correcting codes. Error correcting codes are commonly used in digital communication systems for improving the performance of the system in terms of reduced error rate and/or reduced signal to noise ratio (“SNR”). Error correcting codes introduce redundancy, in a controlled manner, to the data prior to transmission. At the receiver, the structure of the error correcting code and the redundancy in the received data are used to detect and/or correct identified errors.

FIG. 1 shows an exemplary block diagram of a digital communication system 100 that uses error correcting codes. In FIG. 1, the blocks such as the encoder 102, interleaver 104 and modulator 106 are shown as part of a transmit entity 108. The other blocks of the transmit entity 108 such as a controller, data converters, etc., are not shown. In FIG. 1, the blocks such as demodulator 110, deinterleaver 112 and decoder 114 are shown as part of a receive entity 116. The other blocks of the receive entity 116 such as a controller, data converters, etc. are not shown. As used herein, the terms “transmit entity” and “transmitter” are used interchangeably and the terms “receive entity” and “receiver” are also used interchangeably.

At the transmit entity 108, the input data from an information source may be encoded by encoder 102 implementing an error correcting code. In some systems the input data to the encoder of an error correcting code may include an error detection mechanism such as cyclic redundancy code (“CRC”). The encoded data may be further processed before transmission. Often the encoded data may be interleaved to guard against burst errors. The interleaved data is generally modulated by modulator 106 before transmission. In some communication systems, encoding and modulation may be performed jointly, for example, systems that use Trellis Coded Modulation (“TCM”). The transmitted data may be corrupted by noise and other impairments as it propagates through the communication channel 118. At the receive entity 116, the received data is first demodulated by demodulator 110 and then passed on to the deinterleaver 112 which deinterleaves the received data and passes the deinterleaved received data to the decoder 114 for error correction. The output of the decoder 114 is provided to the other subsystems of the communication system for further processing. For example, the output of the decoder may be checked for its correctness by verifying its CRC.

In general, there are two classes of methods for error correction namely Forward Error Correction (“FEC”) and Automatic Repeat Request (“ARQ”). In FEC, the receiver uses the received encoded data and all the information available about the error correction code used by the transmit entity to detect and correct errors that may be present in the received data. In ARQ, the receiver detects the errors that may be present in the received data and, if necessary, requests the transmit entity for retransmission to correct the errors. The encoder of FEC error correction method is referred as FEC encoder and the decoder of FEC error correction method to detect and correct errors is referred as FEC decoder. The ARQ method may be used in combination with the FEC method of error correction. In either case, the terms FEC encoder and FEC decoder are used for the rest of the discussion.

The data transferred between the transmit entity and receive entity may represent different types of information such as voice, images, video, computer data, etc. Different types of information is digitized and represented as a bit stream. It is to be understood that the data being transferred between the transmit entity and the receive entity may take different representations during transmission. However, the data at the input of the FEC encoder at the transmit entity is normally a stream of bits and the data at the output of the FEC decoder at the receive entity is normally a stream of bits.

The input and output of an FEC encoder are in the form of bits. In some communication systems, the output of the FEC encoder is mapped to symbols chosen from a constellation of the modulation technique used. For example, a communication system may be using Quadrature Phase Shift Keying (“QPSK”) modulation and its constellation is shown in FIG. 2. Each symbol in the constellation is associated with a group of two bits. The output of the interleaver, for example, may be grouped into two-bit vectors and these two-bit vectors are used to select one of the 4 symbols from the constellation by the modulator.

The modulated symbol is transmitted through the communication channel. The received symbol at the receiver may be different from the transmitted symbol because as the symbol propagates through of the propagation channel it may experience different impairments. At the receiver, the received symbol is processed by the demodulator. The demodulator determines the most likely transmitted symbol based on the received symbol.

The demodulator may operate in a hard decision mode or a soft decision mode when determining the most likely transmitted symbol and its associated bits based on the received symbol. In hard decision mode, the demodulator outputs the exact bit pattern associated with the most likely symbol based on the received symbol. In soft decision mode, the demodulator outputs the likelihood or probability of each bit being a one or a zero. The output of the demodulator in hard decision mode is referred to as hard bits whereas the output of the demodulator in soft decision mode is referred to as soft bits or soft metrics.

The soft metric represents the degree of confidence the demodulator has about the value of each bit. The FEC decoder may use this likelihood information during the decoding process. Generally a communication system designed with a demodulator and FEC decoder operating in soft decision mode may provide superior performance than the communication system designed with demodulator and FEC decoder operating in hard decision mode.

There are different types of error correcting codes such as Hamming codes, Reed-Solomon (“R-S”) codes, Bose-Hocquenghem-Chaudhuri (“BCH”) codes, convolutional codes, etc. used in practice for FEC. The error correction performance depends on the type of code being used, the amount of redundancy introduced by the error correcting code and the particular implementation of the decoder. There are often different methods for implementing the decoder for a given error correcting code.

A digital communication system may use different types of message formats to exchange data. The messages exchanged between a transmit entity and a receive entity may normally be classified into two types: (i) the messages which are normally used to setup, maintain, and release the communication path for data transfer between the transmit entity and the receive entity and these messages are referred herein as control messages; and (ii) the messages that include user payload data are referred herein as data messages. The specific message formats may vary from one communication system to another.

In general, the value of each bit in a message is equally likely to be one or zero. In a conventional FEC decoder the probability of the individual bits of the message is generally not known and is often assumed to be equally likely.

In general, the structure of a message format may lead to different types of a priori information about different parts of a message, referred herein as a field, as described below.

Some parts of a message may change from one instance to another. This may be the new information that needs to be decoded by the receiver. This part of the message is referred herein as “dynamic.”

For some parts of a message only certain combination of values are allowed. For example, in a particular 3-bit field of a message, only five combinations maybe allowed and the remaining three combinations may not be allowed. This part of the message is referred herein as “constrained-dynamic.”

Some parts of a message may change very infrequently. For example, some parts of the message are identical from one message instance to another for an extended duration. This type of information may need to be decoded very infrequently. This part of the message is referred herein as “semi-static.” An indication of any change in such information may be determined through some other events in the communication system. For example, in a wireless communication system, a number that identifies the transmit entity may always be included in some of the messages. As long as the receive entity is communicating with the same transmit entity, the identifier that identifies the transmit entity may not change. When the receive entity finds another transmit entity that is more suitable for communication, the receive entity may expect different transmit entity identifier when it starts communicating with the new transmit entity.

Some parts of a message may never change. For example, bits reserved for future use, bits used to pad messages for boundary alignment, etc. This part of the message is known and is referred herein as “static.”

Conventional FEC decoders may not exploit the a priori information derived from the structure of message formats and their contents.

### SUMMARY OF THE INVENTION

In accordance with an embodiment of the present invention, a method for decoding a tail-biting convolutionally encoded message output by an encoder and transmitted over a channel is provided. The encoder output is represented by a trellis having initial and final states of the trellis set to the same value. The method comprising receiving a block of the convolutionally encoded message at a receiver; identifying the block as belonging to a particular portion of the message; upon identifying the particular portion of the message, determining a set of static bits in the block using a priori information about the block; reducing the number of possible initial and final trellis states based upon the static bits; calculating branch and state metrics for each stage of the trellis using the reduced number of possible initial and final trellis states; upon determining the state metrics for the last stage of the trellis, determining a state corresponding to a minimum state metric; and applying the minimum state metric to output a decoded message.

In one alternative, the method further comprises re-calculating the branch and state metrics for the block; comparing the calculated and recalculated branch and state metrics; and selecting an optimal minimum state metric based upon the comparison.

In another alternative, the method further comprises setting a preferred initial trellis state to a first value such that the difference between the initial trellis state and the remaining states is larger than the largest possible accumulated state metric after a predetermined number of stages. In an example, the predetermined number of stages is at least 5*K stages, where K is a constraint length of the convolutionally encoded message.

In a further alternative, the state metrics for a first set of states are initialized to the same value such that the difference between the first set of states and the remaining states is larger than the largest possible accumulated state metric after a predetermined number of stages.

In yet another alternative, the method further comprises determining a second set of static bits in the block using additional a priori information about the block; and reducing the number of possible trellis states at an intermediate stage of the trellis based upon the second set of static bits.

In another alternative, the method further comprises eliminating trellis paths that are not possible at each stage of decoding.

In one example, the method is implemented in a Viterbi decoder. In another example, the method is implemented in a MAP decoder.

In a further alternative, a portion of the a priori information about the block is used to detect the validity of the block.

In a further example, a constraint length K of the convolutional code is 7.

In an alternative, the block is an FCH message. In this case, the state metrics for a first set of states may be initialized to the same value such that the difference between the first set of states and the remaining states is larger than the largest possible accumulated state metric after a predetermined number of stages, and wherein the first set of states is states 0, 1, 2 and 3.

In accordance with another embodiment of the present invention, a decoder for decoding a convolutionally encoded message output by an encoder and transmitted over a channel is provided. Here, the encoder output is represented by a trellis having initial and final states of the trellis set to the same value. The decoder comprises a branch metric unit, a state metric unit, an ACS unit and a decisions memory/traceback unit. The branch metric unit is for calculating branch metrics from received symbols of the encoded message. The state metric unit is for calculating state metrics for each stage of the trellis. The ACS unit is for adding the branch metrics and the state metrics, for comparing path metrics and for selecting an optimal path metric. And the decisions memory/traceback unit is for storing the optimal path metric and for outputting decision bits representing a decoded message based on the optimal path metric. During operation, the decoder receives a block of the convolutionally encoded message and identifies the block as belonging to a particular portion of the message. Upon identifying the particular portion of the message, the decoder determines a set of static bits in the block using a priori information about the block and reduces the number of possible initial and final trellis states based upon the static bits prior to the state metric unit calculating the state metrics.

In an alternative, a controller logically associated with the decoder determines the set of static bits and reduces the number of possible initial and final trellis states.

In another alternative, the branch and state metric units are operable during operation to recalculate the branch and state metrics for the block, the ACS unit is operable during operation to compare the calculated and recalculated branch and state metrics, and the decoder is operable during operation to select an optimal minimum state metric based upon the comparison.

In yet another alternative, the decoder is further operable to set a preferred initial trellis state to a first value such that the difference between the initial trellis state and the remaining states is larger than the largest possible accumulated state metric after a predetermined number of stages. In this case, the predetermined number of stages may be at least 5*K stages, where K is the constraint length of the convolutionally encoded message.

In a further alternative, the decoder further determines a second set of static bits in the block using additional a priori information about the block and reduces the number of possible trellis states at an intermediate stage of the trellis based upon the second set of static bits.

In accordance with yet another embodiment of the present invention, a receiver comprises a receive chain, a decoder and a controller. The receive chain is for receiving a convolutionally encoded message output by an encoder of a transmitter and transmitted over a channel. The encoder output is represented by a trellis having initial and final states of the trellis set to the same value. The decoder is operatively coupled to the receive chain and includes a branch metric unit for calculating branch metrics from received symbols of the encoded message, a state metric unit for calculating state metrics for each stage of the trellis, an ACS unit for adding the branch metrics and the state metrics, for comparing path metrics and for selecting an optimal path metric, and a decisions memory/traceback unit for storing the optimal path metric and for outputting decision bits representing a decoded message based on the optimal path metric. The controller is operatively coupled to the decoder. During operation, the decoder receives a block of the convolutionally encoded message and identifies the block as belonging to a particular portion of the message. Upon identifying the particular portion of the message, the controller determines a set of static bits in the block using a priori information about the block and reduces the number of possible initial and final trellis states based upon the static bits prior to the state metric unit calculating the state metrics.

In an alternative, the branch and state metric units are operable to recalculate the branch and state metrics for the block, the ACS unit is operable to compare the calculated and recalculated branch and state metrics, and the controller is operable to select an optimal minimum state metric based upon the comparison.

In another alternative, the decoder or the controller is further operable to set a preferred initial trellis state to a first value such that the difference between the initial trellis state and the remaining states is larger than the largest possible accumulated state metric after a predetermined number of stages. In this case, the predetermined number of stages may be at least 5*K stages, where K is the constraint length of the convolutionally encoded message.

In another alternative, the controller further determines a second set of static bits in the block using additional a priori information about the block and reduces the number of possible trellis states at an intermediate stage of the trellis based upon the second set of static bits.

In accordance with a further embodiment of the present invention, a method for decoding a zero-tail convolutionally encoded message output by an encoder and transmitted over a channel is provided. The encoder output is represented by a trellis having an initial and a final state of the trellis set to the same value. The method comprises receiving a block of the convolutionally encoded message at a receiver; identifying the block as belonging to a particular portion of the message; upon identifying the particular portion of the message, determining at least one static bit in the block using a priori information about the block; reducing the number of trellis states at an intermediate stage of the trellis based upon the at least one static bit; calculating branch and state metrics for each stage of the trellis using the reduced number of trellis states at the intermediate stage; and outputting a decoded message based upon the calculated branch and state metrics.

In one alternative, the method further comprises re-calculating the branch and state metrics for the block; comparing the calculated and recalculated branch and state metrics; and selecting an optimal trellis path based upon the comparison.

In another alternative, the method further comprises setting a preferred trellis state of the intermediate stage to a first value such that the difference between the preferred trellis state and the remaining states of the intermediate stage is larger than the largest possible accumulated state metric after a predetermined number of stages.

In yet another alternative, the method further comprises eliminating trellis paths that are not possible at each stage of decoding.

In one example, the method is implemented in a Viterbi decoder. In another example, the method is implemented in a MAP decoder.

In a further alternative, a portion of the a priori information about the block is used to detect the validity of the block. In yet another alternative, a constraint length K of the convolutional code is 7. And in another alternative, the block is an FCH message.

### BRIEF DESCRIPTION OF THE DRAWINGS

FIG. 1 illustrates a block diagram of a digital communication system.

FIG. 2 illustrates the constellation of QPSK modulation.

FIG. 3 is a diagram illustrating a layout of a cell-type digital wireless cellular communication system.

FIG. 4 illustrates an exemplary frame structure of the IEEE 802.16e digital wireless communication platform with an Orthogonal Frequency Division Multiple Access (“OFDMA”) based physical layer.

FIG. 5 illustrates a format of the Frame Control Header (“FCH”) message.

FIG. 6 illustrates a trellis diagram for a convolutional code with constraint length K=3.

FIG. 7 illustrates an overall FCH encoding process at the transmit entity.

FIG. 8 illustrates initialization of the shift register for a tail-biting convolutional encoder for an FCH message.

FIG. 9 illustrates an FCH decoding process at the receive entity.

FIG. 10 illustrates a Viterbi decoder for use with aspects of the present invention.

FIG. 11 lists the number of possible states for an FCH decoder in accordance with the present invention.

FIG. 12 illustrates an exemplary wireless mobile station for use with aspects of the present invention.

FIG. 13 illustrates an exemplary baseband subsystem for use with aspects of the present invention.

### DETAILED DESCRIPTION

The foregoing aspects, features and advantages of the present invention will be further appreciated when considered with reference to the following description of preferred embodiments and accompanying drawings, wherein like reference numerals represent like elements. In describing preferred embodiments of the invention illustrated in the appended drawings, specific terminology will be used for the sake of clarity. However, the invention is not intended to be limited to the specific terms used.

The invention described herein exploits a priori information based on the structure of message formats and their contents to improve the performance of decoders such as FEC decoders. The methods described herein are applicable to any digital communication system that uses FEC and where the message formats are known a priori. The receiver may know the type of the message received at a given instant of time. Application of the invention is dependent upon the structure of a message format and its contents. Aspects of the invention are illustrated for a structure of a particular message format. However, the invention may be applied to any digital communication system designed with FEC and known structure of message formats.

An example of a priori information based on the structure of a message format is the knowledge about a particular bit being a zero or a one. The a priori information about the bits may be statistical in nature such as probabilities or may be deterministic such as a particular bit may be known to be zero or one. This a priori information may be used by the FEC decoder as described herein.

In order to use the a priori information about the bits of a particular message, it is necessary for the decoder to know the particular message type that is being received and decoded at any given time. In many communication systems, certain control messages are often transmitted at pre-determined instants of time. This is one of the methods by which the receiver may determine the type of message being received at a given instant of time.

As presented herein, a wireless digital communication system based on IEEE 802.16e with an OFDMA-based physical layer is considered for illustration purposes. In this wireless digital communication system control messages and data messages are exchanged between the transmitter and the receiver. The control messages and data messages have specific formats. To better illustrate the invention, the FCH message of the chosen wireless digital communication system is considered.

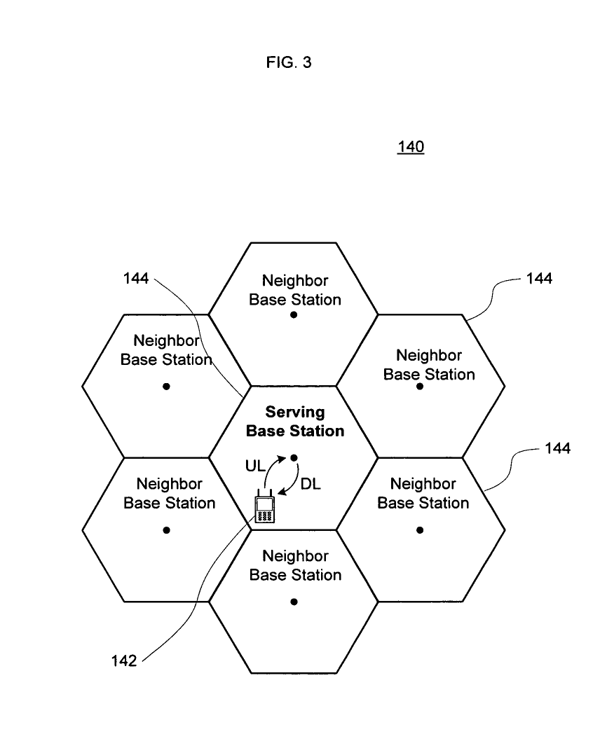

In an IEEE 802.16e OFDMA physical layer based wireless communication system, there are one or more base stations and one or more client terminals as shown in FIG. 3. As shown in the cell-based architecture 140, a client terminal 142 may communicate with one or more base stations 144. The base station 144 in primary communication with the client terminal 142 is identified as a “serving base station” with the surrounding base stations 144 being identified as “neighbor base stations.” Communication from the client terminal 142 to the serving base station 144 is done via an uplink (“UL”) while communication from the serving base station 144 to the client terminal 142 is done via a down link (“DL”). In the chosen example system, the interface between a given client terminal 142 and the base stations 144 is organized in terms of frames. The client terminal 142 receives and decodes different messages, such as FCH, transmitted by the base station 144 at each frame.

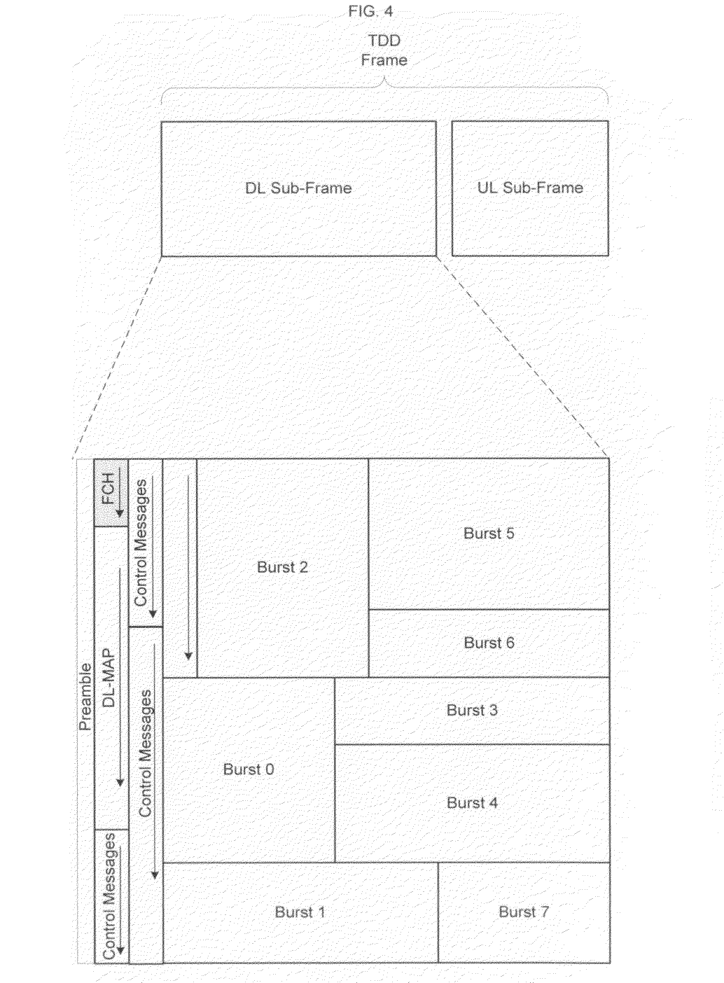

FIG. 4 shows an example of a Time Division Duplex (“TDD”) frame structure used by the IEEE 802.16e wireless communication system based on OFDMA physical layer. Normally a frame is formed of a set of Orthogonal Frequency Division Multiplexing (“OFDM”) symbols. A TDD frame is divided into two sub-frames, namely, one for the DL direction (referred herein as DL sub-frame) and the other for the UL direction (referred herein as UL sub-frame). A slot is the basic resource allocation unit in the IEEE 802.16e wireless communication system based on OFDMA physical layer. Each slot includes 48 modulation symbols. The modulation symbols may be chosen from either QPSK, 16-Quadrature Amplitude Modulation (“QAM”) or 64-QAM constellations.

As shown in FIG. 4, each frame starts with a preamble symbol which enables the receiver to perform time and frequency synchronization. Normally the control messages and the data messages are transmitted following the preamble symbol in the DL sub-frame. The control messages include an FCH message, a Downlink-MAP (“DL-MAP”) message and other control messages. The FCH message contains critical information about the rest of the frame. Therefore, the FCH message must be decoded correctly in order for the receiver to be able to successfully decode the rest of the frame. Some of the attributes of DL-MAP message are described in the FCH message. The attributes of the remaining portion of the DL sub-frame are described in DL-MAP message. In the chosen example of FIG. 4, the DL-MAP message is followed by three control messages and eight bursts. The bursts may carry control messages or user payload data.

There is no error detection capability such as CRC in the FCH message to determine whether the receiver decoded it successfully. An incorrect FCH message prevents the receiver from determining the description of rest of the frame. Failure to correctly decode the FCH message may lead to waste of network bandwidth since the network may have allocated resources in both downlink and uplink directions to the receiver which may be left unused. An incorrect decoded FCH message may also lead the receiver to process the rest of the frame with an incorrect description and which may result in a waste of receiver power.

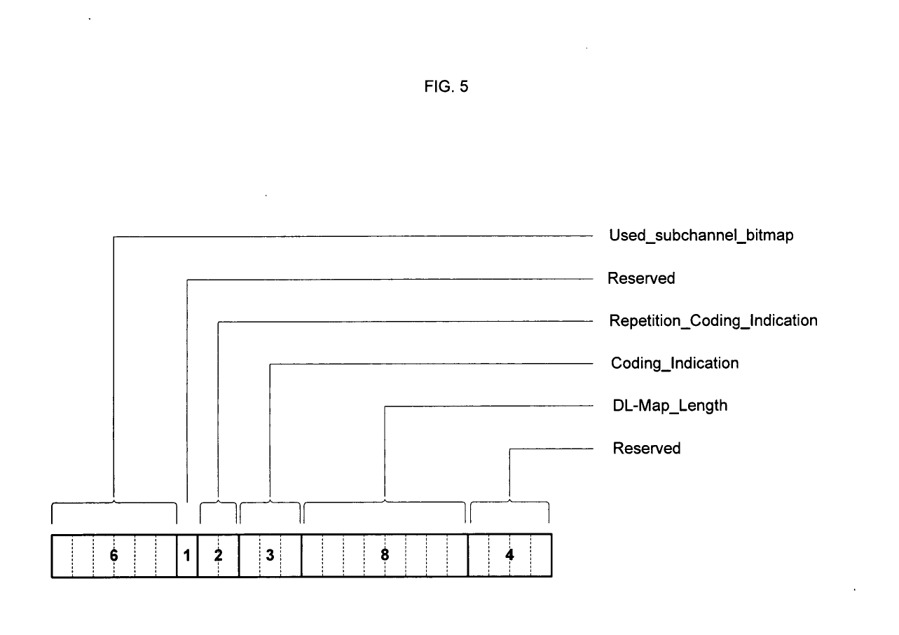

The FCH message contains various fields as shown in FIG. 5. According to an aspect of the invention, various fields in the FCH message may be categorized into the four types of a priori information as described earlier. These fields are discussed below.

### Used Subchannel Bitmap

This field describes the sub channels, i.e., the channel bandwidth resources used by the system. The transmitter in this example is the base station and the receiver is the client terminal. This field is specific to a base station and it may not change from one frame to another. This information is treated as semi-static. The receiver needs to successfully decode this field at least once when it first starts communicating with a particular base station. Once this field is decoded, it may be treated as static since it is already known to the receiver as long as the receiver communicates with the same base station.

### Reserved

This field is reserved for future use and it is set to zero. It is treated as static herein.

### Repetition Coding Indication

This field indicates the type of repetition coding used for the DL-MAP message and there is no particular a priori information about this field. It is treated as dynamic.

### Coding Indication

This field indicates the type of error correcting code used for the DL-MAP message. This is a 3-bit field with eight possible combinations. However, only five combinations are defined in the IEEE 802.16e standard. Among the five defined combinations, only two combinations are supported in the current network deployments. This field may change from one frame to the next and its values are constrained. It is treated as constrained-dynamic.

### DL-Map Length

This field indicates the length of DL-MAP message and there is no particular a priori information about this field. It is treated as dynamic.

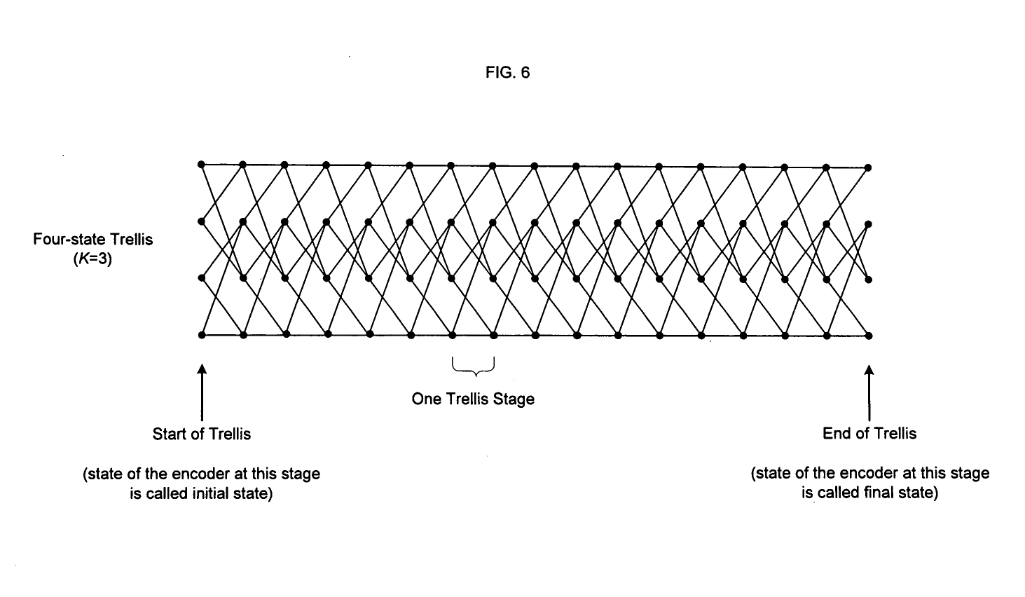

The FCH message contains a total of 24 bits as shown in FIG. 5. To ensure reliable reception, the 24 bits are repeated to form 48 bits and are encoded using a ½ rate, constraint length K=7 tail-biting convolutional code. The state transitions of the encoder for convolutional code may be represented by a trellis diagram. The states of a convolutional encoder are represented by solid circles in a trellis diagram as shown in FIG. 6. The transitions between different states are shown by lines. A stage represents the transition caused by one or more input bits to the convolutional encoder from one state to another state. For a general discussion of trellis diagrams and FEC, see Viterbi, “CDMA—Principles of Spread Spectrum Communication,” © 1995, Addison-Wesley Publishing Co., e.g., § 5.3.

The initial state of the encoder may depend on the type of convolutional code used. For some convolutional codes, the initial state of the encoder is set to zero and the final state of the encoder is also set to zero by inputting extra zeros at the end of the message that is being encoded. This information may be used by the FEC decoder to improve the decoding performance. The process of putting extra zeros at the end of a message in convolutional encoding is referred herein as “zero-tail” convolutional encoding. However, the zero-tail encoding causes extra bits to be transmitted over the communication channel.

An alternative to the zero-tail convolutional encoding is termed “tail-biting” convolutional encoding. In tail-biting encoders, the initial state of the encoder is set according to the last K−1 bits of the message to be encoded. This ensures that the initial state of the encoder is the same as the final state of the encoder. Since the initial and the final states are the same, the trellis generated by the tail-biting convolutional encoder is often referred to as a circular trellis. Tail-biting convolutional encoders do not transmit any extra bits just for forcing the initial and the final states to a certain value. The initial and the final states are the same for a tail-biting convolutional encoder. However, the actual state is not known; whereas in zero-tail convolutional encoders the initial and the final states are known a priori.

A traditional Viterbi decoder may be used for decoding a message that is encoded using tail-biting convolutional encoders. However, since the final state of the encoder is not known, additional processing is required to complete the decoding process. There are different techniques for decoding the tail-biting convolutional coded messages. Many such techniques are based on modification of the traditional Viterbi decoder and take advantage of the fact that the initial and the final states are the same. To achieve optimum performance for decoding tail-biting convolutional coded messages, the decoder must perform significantly larger numbers of operations compared to decoding the zero-tail convolutional coded messages. Often suboptimum approaches are used to achieve a certain performance versus complexity tradeoff for decoding tail-biting convolutional coded messages.

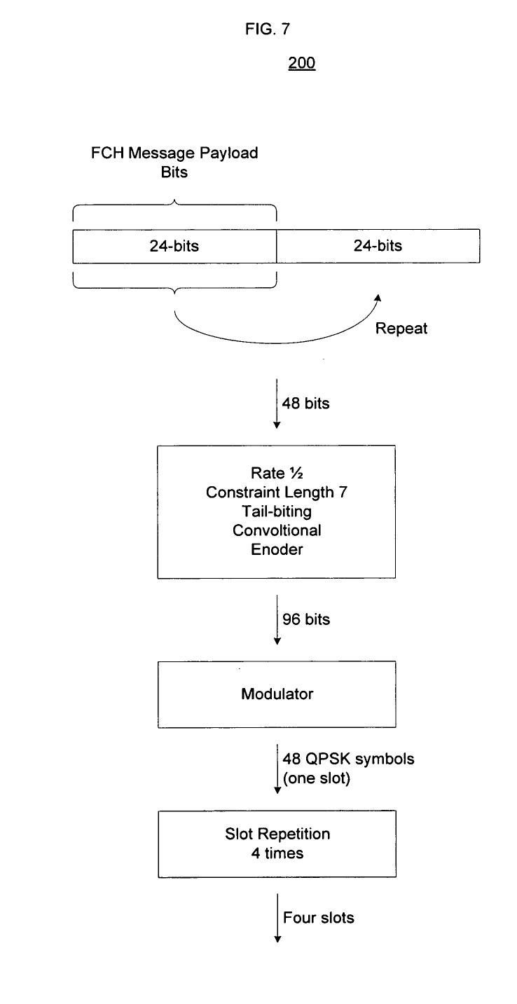

In the present example, the ½ rate tail-biting convolutional encoder outputs 96 bits for the 48-bit input FCH message. The encoded 96 bits are interleaved and mapped to data symbols using the constellation of the QPSK modulation. A slot in IEEE 802.16e OFDMA based physical layer can carry 96-bits when using QPSK modulation. The 96 encoded and interleaved bits of an FCH message are mapped to one complete slot. To further improve the reliability of the FCH message, it is repeated over four slots. The encoding and other processing of an FCH message at the transmit entity is shown in process 200 of FIG. 7.

Some processing such as equalization may be performed on the received data before presenting it into the demodulator. At the receiver, the pre-processed slots of data are combined to take advantage of the slot repetition used by the transmitter. Combining the information received in four slots may be performed before demodulation or after demodulation. If combining is done before demodulation, the combined symbols are then demodulated. At the output of the slot combining and demodulation, there are 96 soft metrics corresponding to 96 bits mapped onto one slot by the transmitter. Since the bits of the FCH message are repeated before convolutional encoding which uses tail-biting encoder, the 96 soft metrics are combined into 48 soft metrics. This allows the trellis for the convolutional decoder to be shorter.

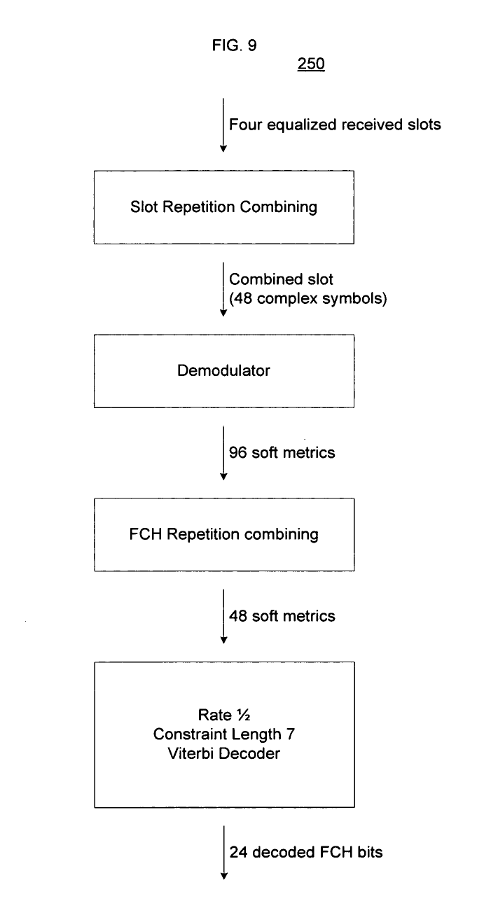

The Viterbi decoder is the most commonly used algorithm/architecture for decoding data that is encoded using convolutional encoder. The trellis created by the tail-biting encoders is considered as circular since the initial state and final state are the same. A Viterbi decoder at the receiver may operate over the same received data several times, possibly in a circular manner due to the circular trellis, to ensure reliable detection of initial and final states. The overall FCH message decoding process 250 is shown in FIG. 9.

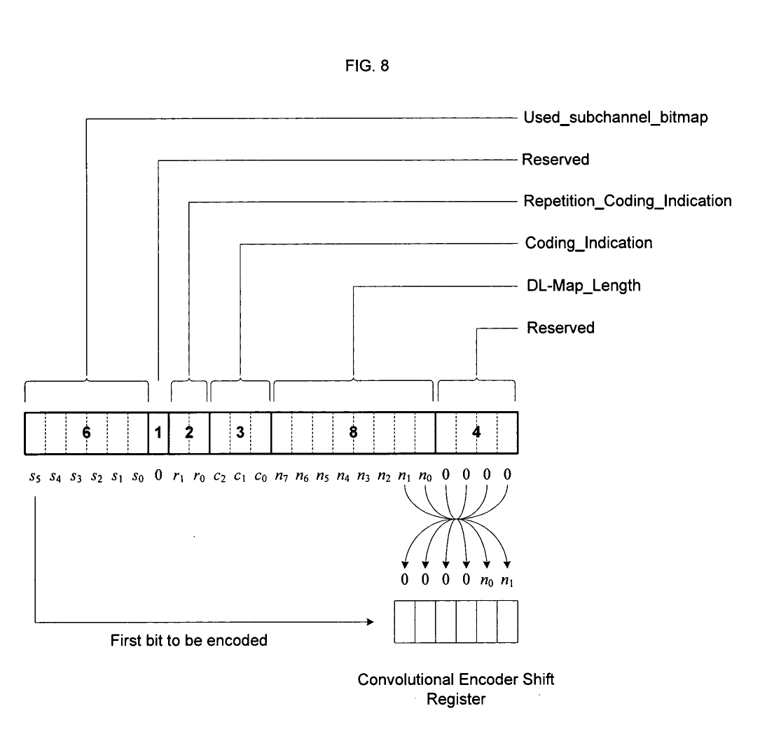

The FEC decoder that decodes the FCH message is referred herein as an FCH decoder. The FCH decoder according to an aspect of the current invention is described next. For a tail-biting convolutional encoder the initialization of the encoder state is done such that the initial state of the encoder is same as the final state after the last bit of the message is encoded. This is achieved by initializing the state of the convolutional encoder with the last K−1=6-bits of the FCH message as shown in FIG. 8. This means that the initial state of the encoder may have only four possible values since the last four bits of the FCH message are static and are known to be zero. Since a tail-biting encoder is used, the initial and final states of the encoder are the same. Use of this static a priori information according to an aspect of the invention enables the decoder in the receiver to have an improved performance as detailed below.

The convolutional code used for the FCH message has constraint length K=7. The trellis created by this code has 2⁷⁻¹=64 states. The conventional Viterbi decoder at the receiver generally needs to consider the entire 64-state trellis. Typically for tail-biting Viterbi decoders all the state metrics are initialized with the same value since the initial state of the trellis is not known. Similarly, the 64-state trellis may in general terminate in any one of the 64 states.

In accordance with aspects of the present invention, by using the value of the last four Reserved bits which are static, the number of trellis states for the FCH message may be reduced to four states instead of 64 states for the initial and the final stages of the Viterbi decoder. According to an aspect of the invention described herein, the Viterbi decoder for the FCH message may consider only four possible initial and final states and thus eliminate trellis paths that are not possible for the FCH message from consideration during decoding. This prevents the decoder from pursuing trellis paths that are not possible, which in turn may improve the FCH decoding performance.

The Viterbi decoder is used for maximum-likelihood sequence detection of data that has been convolutionally encoded. Let K denote the constraint length of the code and let L denote the length of the input bit stream to be encoded. For binary encoders, the corresponding trellis is composed of L+1 stages with 2^{K-1} states each.

A branch metric corresponding to a branch that connects two states in adjacent stages in a trellis is a measure for the likelihood that this branch was taken at the encoder given the received noisy data. For each stage the Viterbi decoder computes all the possible branch metrics. There are two or more paths merging at each state in a trellis. At a given stage n, the path metric for a given path may be computed by adding the branch metric for that path and the state metric corresponding to the state from which the path originates at stage n−1.

The state metric for a given state is equal to the minimum of the path metrics of all the paths that are merging into that state. For example, there are two paths merging into state 0, the upper path is originating from state 0 of previous stage and the lower path is originating from state 1 of previous stage as shown in FIG. 6. At a given stage n, the branch metric corresponding to the upper branch is added to the state metric corresponding to state 0 at stage n−1. Similarly the branch metric of the lower branch is added to the state metric corresponding to state 1 at stage n−1.

The state metrics are computed for all the states for a given stage. This process is performed for all the stages in the trellis. After computing the state metrics of the last stage of the trellis, the state corresponding to the minimum state metric is determined. The decoded message may be obtained by tracing back in the trellis starting from the state corresponding to the minimum state metric.

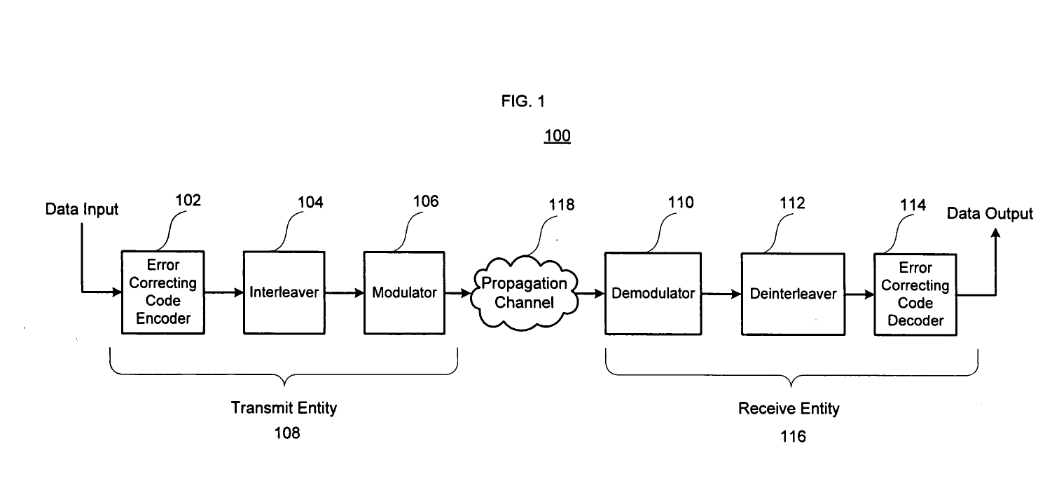

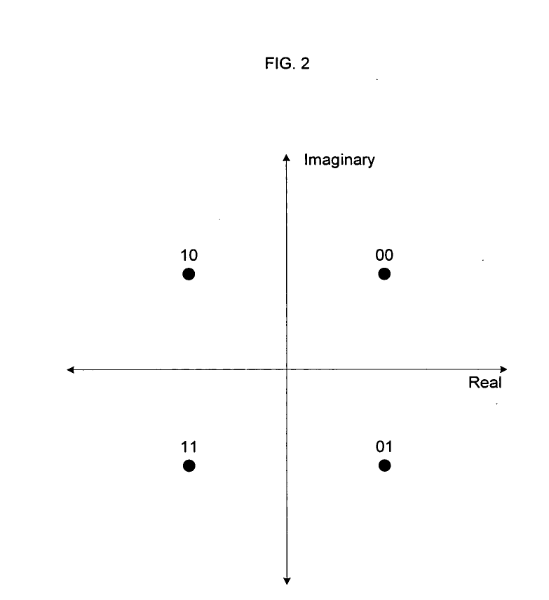

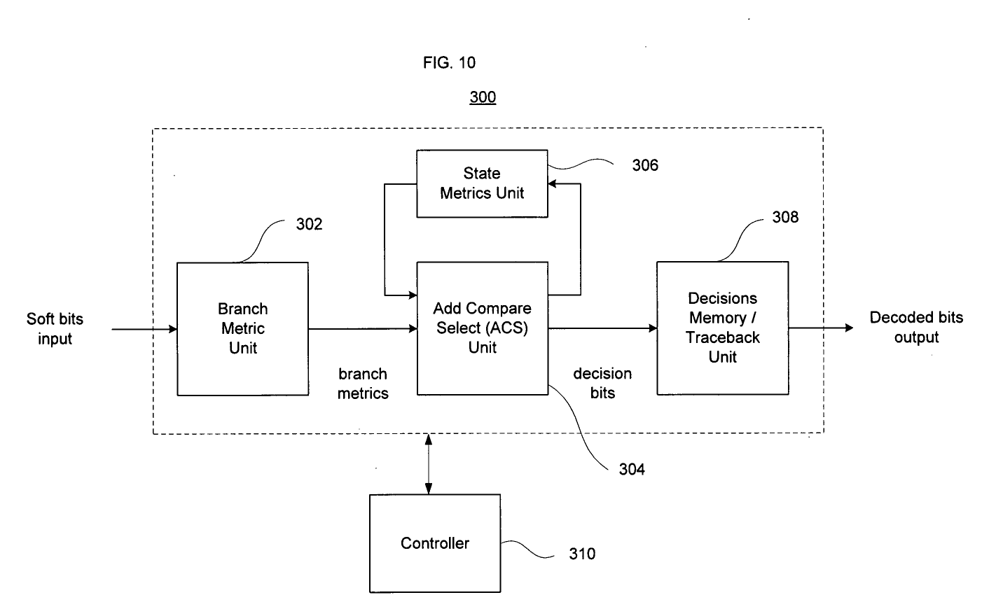

The above operations may be implemented using an architecture shown in FIG. 10. In particular, FIG. 10 illustrates an exemplary Viterbi decoder 300 which includes a branch metric unit 302, an add/compare/select (“ACS”) unit 304, a state metrics unit 306 and a decisions memory/traceback unit 308. The decoder 300 may be implemented as part of an error correcting code decoder such as block 114 of FIG. 1. While not shown, the decoder 300 may include a temporary/buffer memory for storing data such as intermediate metric data and/or a non-volatile memory/ROM for storing program information for executing various operations. A controller or other processor/firmware 310 may manage overall operation of the decoder 300. The controller 310 may be integral to the decoder 300 or may be a separate controller such as a CPU or microcontroller.

The branch metric unit 302 is operable to calculate branch metrics from received symbols. The branch metrics are provided to the ACS unit 304, which also receives state metrics from the state metric unit 306. The ACS 304 is operable to add the branch metrics and the state metrics, compare path metrics and select an optimal path metric. The selected optimal path metric is stored in the state metric unit 306 and it is used as the state metric for the next stage. The decision bits indicate the optimum path selected at the ACS unit 304 for each state at a given stage. At the final stage of the trellis, the decoded bits may be obtained by tracing back in the trellis using the decision bits starting from the state corresponding to the minimum state metric.

Processing one block of received data from start to end is referred to herein as one run of the decoder. For example, a block of data may be an FCH message and may be processed from start to end in one run of the decoder 300. Sometimes the decoder may run multiple times on the same block of data for reliable decoding when the data is encoded by tail-biting convolutional code. It is to be noted that some messages may be formed by multiple blocks of received data.

According to an aspect of the invention, the Viterbi decoder may run four times on the same 48 soft metrics for improved decoding of the FCH message. In general, there are 64 possible initial and final states. However, in accordance with an aspect of the present invention described herein, there are only four possible initial and final states for the FCH message; namely 0, 1, 2 and 3 as can be seen from the initialization bits n₀ and n₁ shown in FIG. 8. For the first run of the Viterbi decoder, the state metric for state 0 is initialized to a value that is much lower than the initial value of the remaining 63 states. For example, the initial values of the state metrics may be chosen such that the difference between the preferred state and the remaining 63 states is larger than the largest possible accumulated state metric after 5×K stages. The number of stages 5×K may be determined empirically. For example, for a rate ½ code with a maximum absolute soft value of 8, the maximum difference between state metrics per stage may be 2×8=16. For K=7, the total difference between state metrics may be 16×5×7=560. Therefore the preferred state such as state 0 may be initialized to zero and the remaining 63 states may be initialized to 560 or larger.

At the end of the first run, the final value of the state metric of state 0 is stored in memory. For the second run of the Viterbi decoder, the state metric for state 1 is initialized to a value that is much lower than the initial value of the remaining 63 states. The initial values of the state metrics may be chosen as explained for the first run of the Viterbi decoder. At the end of the second run, the final value of the state metric of state 1 is compared with the final state metric value stored in memory obtained from previous run and the minimum is stored in the memory. This is continued for states 2 and 3. The decoded sequence corresponding to the lowest of the final state metric is chosen as the decoded FCH message.

According to another aspect of the invention, the state metrics for states 0, 1, 2 and 3 in a Viterbi decoder may be initialized to the same value, which is much lower than the initial value of the remaining 60 states. The initial values of the state metrics may be chosen as described above. After performing one run of the Viterbi decoder over the 48 soft bits, the state metrics of only the four possible final states 0, 1, 2, or 3 are searched for the minimum, i.e., the remaining 60 states are not considered as possible terminating states. The decoded message may be obtained by tracing back in the trellis starting from the state corresponding to the minimum state metric.

According to another aspect of the invention, the other a priori information about the FCH message may be used as follows. After the first successful decoding of the FCH message, the 6-bit Used_subchannel_bitmap field becomes known. Also a 1-bit Reserved field of type static follows the Used_subchannel_bitmap field in the FCH message. Therefore, there are 7 bits of type static. Using this information, at the second stage of the trellis there are only two possible states since bit n₁ is shifted out from the shift register and the known bit s₅ enters the shift register after the first stage. At the third stage, there is only one possible state since bit n₀ is shifted out from the shift register and the known bit s₄ enters the shift register after the first stage. For the next five stages there is only one possible state in the trellis.

For the 3-bit Coding_Indication field, there are only two combinations of 3-bit pattern allowed in the IEEE 802.16e systems that are currently deployed. Specifically, the two allowed bit patterns are “000” and “010.” As can be seen only the middle bit namely c₁ is changing between the two allowed patterns. The value of remaining two bits namely c₂ and c₀ does not change and may be treated as static.

The trellis for the decoder as described in this invention does not grow to full 64 states until the first 6-bits of the DL-Map_Length field are being processed. The trellis starts to shrink again after the last bit of the DL-Map_Length field is processed since the last four bits of FCH message are known to be zero. As noted before, there are only four possible states for the last stage of trellis.

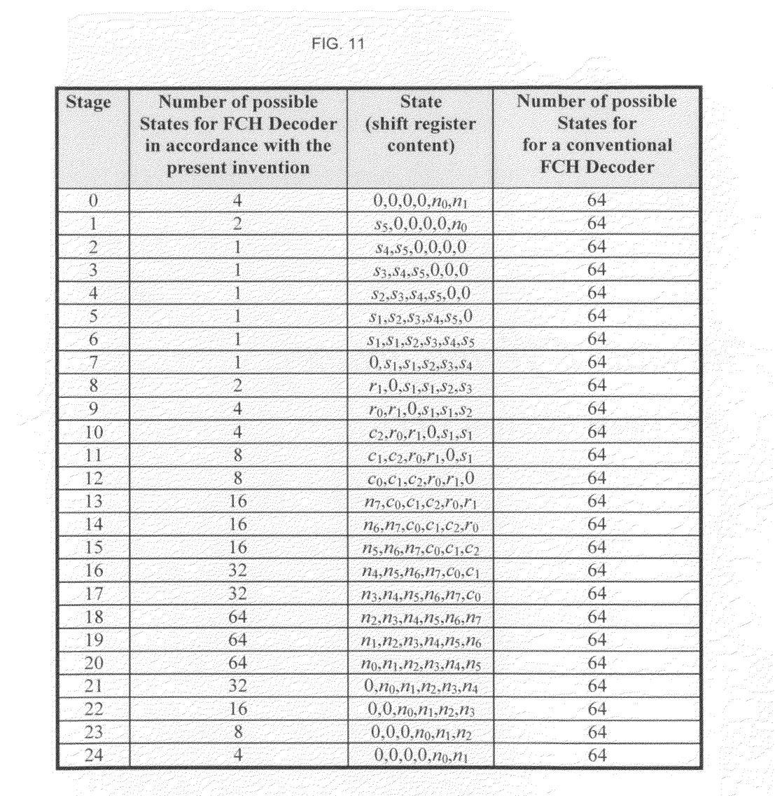

According to another aspect of the invention, the Viterbi decoder described herein takes advantage of the known bits by eliminating trellis paths that are not possible at each stage of decoding. This improves decoding performance because this method prevents the decoder from taking erroneous paths from consideration. The content of the encoder shift register and the number of possible states at each stage of decoding the FCH message are shown in FIG. 11, assuming that the Used_subchannel_bitmap is already known. As can been seen in FIG. 11, a conventional FCH decoder may consider all the 64 states for each stage. However, the number of states considered at each stage is significantly lower in accordance with the invention described herein as shown in FIG. 11.

The FCH decoder may use all or some of the a priori information in the FCH message format. For example, using only the a priori information about the last four bits of the FCH message allows the Viterbi decoder to reduce the number of initial and final states from 64 to 4. This reduction in number of possible states in initial and final states may improve the decoding performance and reduce the complexity of the decoder.

The use of a priori information about a message in the decoding process is not limited to the Viterbi decoder. It may be used in other decoders as well as in other types of error correcting codes. For example, the aspects of the invention may be used for a Maximum A posteriori Probability (“MAP”) decoder, which is often used for decoding turbo codes. In MAP decoders, a priori information derived from the structure of message formats and their contents may be used to initialize the initial and final states of the decoder to improve the performance. When the values of one or more bits of the message are static (known a priori), this information may be used in place of the estimated a priori probabilities.

The degree of improvement in decoding performance depends on the particular message format and the portion of the message that is known a priori. It is understood that the methods described in accordance with aspects of the present invention may be applied to different message formats with appropriate modifications.

Although the invention described herein uses the demodulator and the FEC decoder operating in soft decision mode, the invention described herein may be applied to demodulator and FEC decoder that may operate in hard decision mode. Hard decision mode operation would be the same as for soft decision mode.

According to another aspect of the invention, some of the a priori information may be used to detect the validity of the messages in addition to or in lieu of improving the decoding performance for these messages. For example, the decoder for FCH message may use the a priori information about the four Reserved bits at the end of the message for improving the decoding performance. After the decoding is finished, the remaining a priori information that was not used during message decoding may be used to detect any uncorrected errors in the decoded message. For example, the following checks may be made on the decoded FCH message: The decoded Used_subchannel_bitmap field may be checked against the known value from the previously decoded FCH message; the Coding_Indication field may only be one of the allowed combinations; the DL-Map_Length field must be an integral multiple of the repetition value of the Repetition_Coding_Indication field; the 1-bit Reserved field must be zero.

When an erroneous FCH message is detected, the receiver may choose not to process the rest of the frame since it may be unable to decode the rest of the frame without correct description of the frame. By stopping the receiver from processing a frame using incorrect description leads to reduction in power consumption.

Often, the format of different messages may have some common structure for a given communication system. An aspect of the invention is to derive the a priori information based on the common structure of some or all of the messages. This a priori information based on the common structure is used to improve the performance of the FEC decoder.

The invention described herein offers the following advantages:
Improved rate of successful message decoding.
Improved receiver throughput by improved message decoding which in turn enables improved decoding of the rest of the frame. This reduces retransmissions, power consumption and transmission delay. Reducing retransmissions minimizes the interference and it leads to improve the overall communication system efficiency.
Detection of some message decoding failures may be used to turn off the receiver processing for the remainder of the frame to reduce power consumption.
Reduction in power consumption, which is a significant advantage for battery operated client terminals.

While examples are provided herein with reference to a digital wireless communication system based on IEEE 802.16e standard, aspects of the present invention may be applied to all types of digital communications systems and the like where the characteristics of the messages are known a priori. Examples of such digital communication systems include systems based on an IEEE 802.11 standard, an IEEE 802.20 standard, a T-DMB standard, a DVB-T standard, a DVB-H standard, a MediaFLO standard, a Wideband Code Division Multiple Access (“WCDMA”) standard, a Long Term Evolution of 3G-type systems standard, cable modem standard, DSL standard, etc.

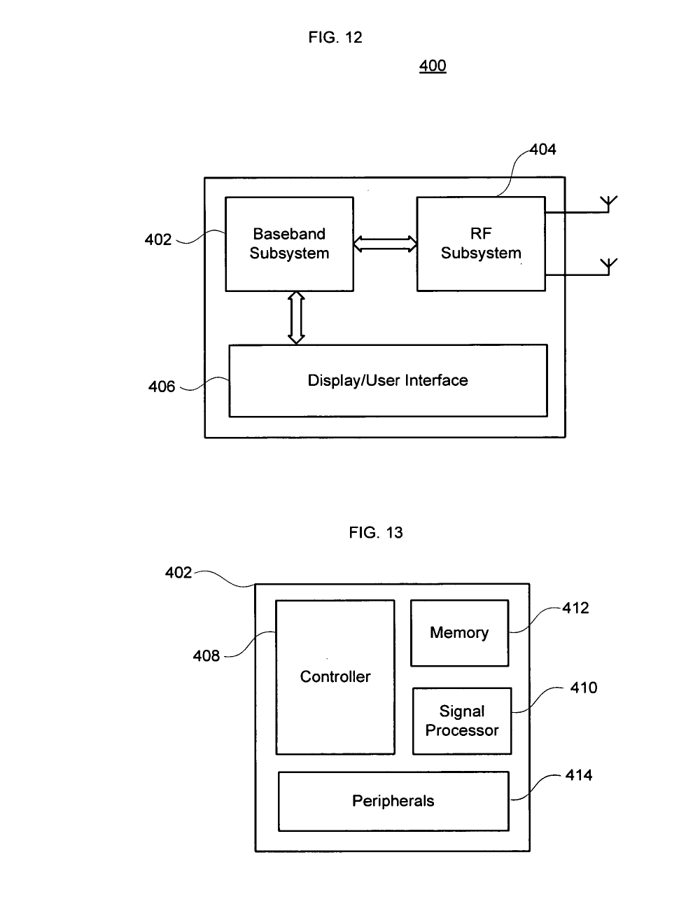

By way of example only, the above-described methods may be implemented in a receiver. The receiver may be a stationary device or a user device such as a wireless mobile station (“MS”), which are collectively referred to herein as client terminals. As shown in FIG. 12, a MS 400 may include a baseband subsystem 402 and a radio frequency (“RF”) subsystem 404 for use with a wireless communication network. A display/user interface 406 provides information to and receives input from the user. By way of example, the user interface may include one or more actuators, a speaker and a microphone.

The baseband subsystem 402 as shown in FIG. 13 may include a controller 408 such as a microcontroller or other processor. The controller 408 desirably handles overall operation of the MS 400, including management of the RF subsystem 404. This may be done by software or firmware running on the controller 408. Such software/firmware may embody any methods in accordance with aspects of the present invention.

A signal processor 410 may be used to process samples from the RF subsystem 404 or other information sent or received by the MS 400. The signal processor 410 may be a stand-alone component or may be part of the controller 408. Memory 412 may be shared by or reserved solely for one or both of the controller 408 and the signal processor 410. For instance, signal processing algorithms may be stored in a non-volatile section of memory 412 while coefficients and other data parameters may be stored in RAM. Peripherals 414 such as a full or partial keyboard, video or still image display, audio interface, etc may be employed and managed through the controller 408.

The RF subsystem 404 preferably provides two-way communication operation. It may include one or more receivers/receive chains, a transmitter, a synthesizer, a power amplifier, and one or more antennas operatively coupled together to enable communication. The receive chain(s) is operable to receive signals from one or more channels in a wireless communication network. Aspects of the present invention may be implemented in firmware of the signal processor 410 and/or the controller 408 of the baseband subsystem. In another alternative, aspects of the present invention may also be implemented as a combination of firmware and hardware of the baseband subsystem. For instance, an FEC decoder such as a Viterbi decoder operating as explained herein may be implemented in firmware, hardware and/or software. It may be part of the baseband subsystem, the receiver subsystem or be associated with both subsystems. In one example, the controller 408 and/or the signal processor 410 may include or control the Viterbi decoder circuitry. The software may reside in internal or external memory and any data may be stored in such memory. The hardware may be an application specific integrated circuit (“ASIC”), field programmable gate array (“FPGA”), discrete logic components or any combination of such devices. The terms controller and processor are used interchangeably herein.

In another alternative, aspects of the present invention may be implemented in network elements in addition to or distinct from implementation in mobile stations. For instance, one or more base stations of a wireless communication network may employ a baseband subsystem and/or an RF subsystem such as those detailed above. Software and/or firmware embodying any of the methods in accordance with aspects of the present invention may be executed by a controller or signal processor of the baseband subsystem. In another alternative, aspects of the present invention may also be implemented as a combination of firmware and hardware of the baseband subsystem.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. Method steps may be performed in different orders unless expressly stated otherwise. Aspects of each embodiment may be employed in the other embodiments described herein.

1. A method for decoding a tail-biting convolutionally encoded message output by an encoder and transmitted over a channel, the encoder output represented by a trellis having initial and final states of the trellis set to the same value, the method comprising:
receiving a block of the convolutionally encoded message at a receiver;
identifying the block as belonging to a particular portion of the message;
upon identifying the particular portion of the message, determining a set of static bits in the block using a priori information about the block;
reducing the number of possible initial and final trellis states based upon the static bits;
calculating branch and state metrics for each stage of the trellis using the reduced number of possible initial and final trellis states;
upon determining the state metrics for the last stage of the trellis, determining a state corresponding to a minimum state metric; and
applying the minimum state metric to output a decoded message.

2. The method of claim 1, further comprising:
re-calculating the branch and state metrics for the block;
comparing the calculated and recalculated branch and state metrics; and
selecting an optimal minimum state metric based upon the comparison.

3. The method of claim 1, further comprising setting a preferred initial trellis state to a first value such that the difference between the initial trellis state and the remaining states is larger than the largest possible accumulated state metric after a predetermined number of stages.

4. The method of claim 3, wherein the predetermined number of stages is at least 5*K stages, where K is a constraint length of the convolutionally encoded message.

5. The method of claim 1, wherein the state metrics for a first set of states are initialized to the same value such that the difference between the first set of states and the remaining states is larger than the largest possible accumulated state metric after a predetermined number of stages.

6. The method of claim 1, further comprising:
determining a second set of static bits in the block using additional a priori information about the block; and
reducing the number of possible trellis states at an intermediate stage of the trellis based upon the second set of static bits.

7. The method of claim 1, further comprising eliminating trellis paths that are not possible at each stage of decoding.

8. The method of claim 1, wherein the method is implemented in a Viterbi decoder.

9. The method of claim 1, wherein the method is implemented in a MAP decoder.

10. The method of claim 1, wherein a portion of the a priori information about the block is used to detect the validity of the block.

11. The method of claim 1, wherein a constraint length K of the convolutional code is 7.

12. The method of claim 1, wherein the block is an FCH message.

13. The method of claim 12, wherein the state metrics for a first set of states are initialized to the same value such that the difference between the first set of states and the remaining states is larger than the largest possible accumulated state metric after a predetermined number of stages, and wherein the first set of states is states 0, 1, 2 and 3.

14. A decoder for decoding a convolutionally encoded message output by an encoder and transmitted over a channel, the encoder output represented by a trellis having initial and final states of the trellis set to the same value, the decoder comprising:
a branch metric unit for calculating branch metrics from received symbols of the encoded message;
a state metric unit for calculating state metrics for each stage of the trellis;
an ACS unit for adding the branch metrics and the state metrics, for comparing path metrics and for selecting an optimal path metric; and
a decisions memory/traceback unit for storing the optimal path metric and for outputting decision bits representing a decoded message based on the optimal path metric;
wherein the decoder receives a block of the convolutionally encoded message and identifies the block as belonging to a particular portion of the message; and
upon identifying the particular portion of the message, the decoder determines a set of static bits in the block using a priori information about the block and reduces the number of possible initial and final trellis states based upon the static bits prior to the state metric unit calculating the state metrics.

15. The decoder of claim 14, wherein a controller logically associated with the decoder determines the set of static bits and reduces the number of possible initial and final trellis states.

16. The decoder of claim 14, wherein the branch and state metric units are operable to recalculate the branch and state metrics for the block, the ACS unit is operable to compare the calculated and recalculated branch and state metrics, and the decoder is operable to select an optimal minimum state metric based upon the comparison.

17. The decoder of claim 14, wherein the decoder is further operable to set a preferred initial trellis state to a first value such that the difference between the initial trellis state and the remaining states is larger than the largest possible accumulated state metric after a predetermined number of stages.

18. The decoder of claim 17, wherein the predetermined number of stages is at least 5*K stages, where K is the constraint length of the convolutionally encoded message.

19. The decoder of claim 14, wherein the decoder further determines a second set of static bits in the block using additional a priori information about the block and reduces the number of possible trellis states at an intermediate stage of the trellis based upon the second set of static bits.

20. A receiver comprising:
a receive chain for receiving a convolutionally encoded message output by an encoder of a transmitter and transmitted over a channel, the encoder output represented by a trellis having initial and final states of the trellis set to the same value
a decoder operatively coupled to the receive chain, the decoder including:
a branch metric unit for calculating branch metrics from received symbols of the encoded message;
a state metric unit for calculating state metrics for each stage of the trellis;
an ACS unit for adding the branch metrics and the state metrics, for comparing path metrics and for selecting an optimal path metric; and
a decisions memory/traceback unit for storing the optimal path metric and for outputting decision bits representing a decoded message based on the optimal path metric; and
a controller operatively coupled to the decoder, wherein the decoder receives a block of the convolutionally encoded message and identifies the block as belonging to a particular portion of the message, and upon identifying the particular portion of the message, the controller determines a set of static bits in the block using a priori information about the block and reduces the number of possible initial and final trellis states based upon the static bits prior to the state metric unit calculating the state metrics.

21. The receiver of claim 20, wherein the branch and state metric units are operable to recalculate the branch and state metrics for the block, the ACS unit is operable to compare the calculated and recalculated branch and state metrics, and the controller is operable to select an optimal minimum state metric based upon the comparison.

22. The receiver of claim 20, wherein the decoder or the controller is further operable to set a preferred initial trellis state to a first value such that the difference between the initial trellis state and the remaining states is larger than the largest possible accumulated state metric after a predetermined number of stages.

23. The receiver of claim 22, wherein the predetermined number of stages is at least 5*K stages, where K is the constraint length of the convolutionally encoded message.

24. The receiver of claim 20, wherein the controller further determines a second set of static bits in the block using additional a priori information about the block and reduces the number of possible trellis states at an intermediate stage of the trellis based upon the second set of static bits.

25. A method for decoding a zero-tail convolutionally encoded message output by an encoder and transmitted over a channel, the encoder output represented by a trellis having an initial and a final state of the trellis set to the same value, the method comprising:
receiving a block of the convolutionally encoded message at a receiver;
identifying the block as belonging to a particular portion of the message;
upon identifying the particular portion of the message, determining at least one static bit in the block using a priori information about the block;
reducing the number of trellis states at an intermediate stage of the trellis based upon the at least one static bit;
calculating branch and state metrics for each stage of the trellis using the reduced number of trellis states at the intermediate stage; and
outputting a decoded message based upon the calculated branch and state metrics.

26. The method of claim 25, further comprising:
re-calculating the branch and state metrics for the block;
comparing the calculated and recalculated branch and state metrics; and
selecting an optimal trellis path based upon the comparison.

27. The method of claim 25, further comprising setting a preferred trellis state of the intermediate stage to a first value such that the difference between the preferred trellis state and the remaining states of the intermediate stage is larger than the largest possible accumulated state metric after a predetermined number of stages.

28. The method of claim 25, further comprising eliminating trellis paths that are not possible at each stage of decoding.

29. The method of claim 25, wherein the method is implemented in a Viterbi decoder.

30. The method of claim 25, wherein the method is implemented in a MAP decoder.

31. The method of claim 25, wherein a portion of the a priori information about the block is used to detect the validity of the block.

32. The method of claim 25, wherein a constraint length K of the convolutional code is 7.

33. The method of claim 25, wherein the block is an FCH message.
